(19) United States
(12) Patent Application Publication
(10) Pub. No.: US 2023/0065090 A1
(43) Pub. Date: Mar. 2, 2023

(54) METHOD FOR BEING ALLOCATED, BY UE, RESOURCE RELATED TO FULL-DUPLEX RADIO IN WIRELESS COMMUNICATION SYSTEM AND DEVICE THEREFOR

(71) Applicant: LG ELECTRONICS INC., Seoul (KR)

(72) Inventor: Donggeun KIM, Seoul (KR)

(73) Assignee: LG ELECTRONICS INC., Seoul (KR)

(21) Appl. No.: 17/797,411

(22) PCT Filed: Mar. 5, 2020
(86) PCT No.: PCT/KR2020/095025

§ 371 Date: Aug. 3, 2022

(51) Int. Cl. H04W 72/04; H04L 5/14

(52) U.S. Cl. CPC H04W 72/048; H04L 5/14; H04W 72/042

(57) ABSTRACT

Various embodiments provide a method for being allocated a resource, and a device therefor. The method may comprise the steps of: reporting a self-interference removal capability related to FDR to a base station; and receiving, from the base station, resource allocation information relating to preconfigured time intervals separated into a first time resource interval and a second time resource interval, wherein the first time resource interval is a time resource interval allocated for simultaneous performing of transmission of an uplink signal and reception of a downlink signal in the same frequency band, the second time resource interval is a time resource interval allocated for transmission of the uplink signal or reception of the downlink signal, and the lengths of the first time resource interval and the second time resource interval are determined on the basis of the self-interference removal capability.

### TECHNICAL FIELD

The present disclosure relates to a method of receiving, by a user equipment (UE), allocation of resources related to full-duplex radio (FDR) in a wireless communication system supporting the FDR and apparatus therefor.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic.

Also, the UE or vehicle may receive resource allocation for an uplink signal and a resource allocation for a downlink signal from the base station. The UE or vehicle may be allocated resources for the uplink signal from the base station through uplink control information (UCI), or may receive resources for the downlink signal from the base station through uplink control information (DCI).

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

### DISCLOSURE

### Technical Problem

An object of the present disclosure is to provide a method of receiving allocation of a first time resource period for performing full-duplex radio (FDR) and allocation of a second time resource period for performing half-duplex radio separately and receiving allocation of a modulation and coding scheme (MCS) related to the first time resource period and allocation of an MCS related to the second time resource period separately in order to effectively improve the efficiency and data throughput of an FDR system.

It will be appreciated by those of ordinary skill in the art to which the embodiment(s) pertain that the objects that could be achieved with the embodiment(s) are not limited to what has been particularly described hereinabove and the above and other objects will be more clearly understood from the following detailed description.

### Technical Solution

In an aspect of the present disclosure, there is provided a method of receiving, by a user equipment (UE), allocation of resources related to full-duplex radio (FDR) in a wireless communication system. The method may include: reporting a self-interference cancellation capability related to the FDR to a base station; and receiving resource allocation information on a predetermined time resource period divided into a first time resource period and a second time resource period from the base station. The first time resource period may be a time resource period allocated to simultaneously perform transmission of an uplink signal and reception of a downlink signal in a same frequency band, and the second time resource period may be a time resource period allocated to perform either the transmission of the uplink signal or the reception of the downlink signal. Lengths of the first time resource period and the second time resource period may be determined based on the self-interference cancellation capability, a first data amount related to the uplink signal, and a second data amount related to the downlink signal.

Alternatively, for the downlink signal, when the second data amount is greater than the first data amount, a first modulation and coding scheme (MCS) and a second MCS may be applied to the first time resource period and the second time period, respectively.

Alternatively, the first MCS and the second MCS may be obtained based on the resource allocation information.

Alternatively, the first MCS may be determined based on a reference signal received power (RSRP), a signal to interference noise ratio (SINR), and the self-interference cancellation capability measured by the UE.

Alternatively, information on the first MCS may be determined based on SINR_{FD} calculated from the following equation.

$$S I N {R}_{F D} = \frac{R S R P \times S I N R}{R S R P + \left(T P \times S {I}^{i}\right) \times S I N R}$$

In the above equation, SIⁱ denotes the self-interference cancellation capability, and TP denotes a transmit power.

Alternatively, a length of the first time resource period may be determined based on a smaller of the first data amount and the second data amount.

Alternatively, a length of the second time resource period may be determined based on a difference between the first data amount and the second data amount.

Alternatively, the resource allocation information may further include information on an offset for specifying the first time resource period.

Alternatively, the offset may be a difference between a start timing of the first time resource period and a start timing of the predetermined time resource period.

Alternatively, when the second data amount is smaller than the first data amount, the uplink signal may be transmitted by applying a first MCS and a second MCS to the first time resource period and the second time resource period, respectively.

Alternatively, the resource allocation information may be received in downlink control information (DCI).

Alternatively, the UE may operate based on the FDR in the first time resource period and operates based on half-duplex radio (HDR) in the second time resource period.

Alternatively, a frequency band related to a first orthogonal frequency division multiplexing (OFDM) symbol may correspond to a frequency band related to the second time resource period.

In another aspect of the present disclosure, there is provided a method of allocating, by a base station, resources to a UE in a wireless communication system supporting FDR. The method may include: receiving a report on a self-interference cancellation capability related to the FDR from the UE; determining a first time resource period in which transmission of an uplink signal and reception of a downlink signal are simultaneously performed in a same frequency band for a predetermined time period and a second time resource period in which either the transmission of the uplink signal or the reception of the downlink signal is performed; and transmitting resource allocation information including information on the first time resource period and the second time resource period to the UE. A length of the first time resource period and a length of the second time resource period may be determined based on the self-interference cancellation capability, a first data amount related to the uplink signal, and a second data amount related to the downlink signal.

In a further aspect of the present disclosure, there is provided a UE configured to receive allocation of resources in a wireless communication system supporting FDR. The UE may include: a radio frequency (RF) transceiver; and a processor connected to the RF transceiver. The processor may be configured to control the RF transceiver to report a self-interference cancellation capability related to the FDR to a base station and receive resource allocation information on a predetermined time period divided into a first time resource period and a second time resource period from the base station. The first time resource period may be a time resource period allocated to simultaneously perform transmission of an uplink signal and reception of a downlink signal in a same frequency band, and the second time resource period may be a time resource period allocated to perform either the transmission of the uplink signal or the reception of the downlink signal. Lengths of the first time resource period and the second time resource period may be determined based on the self-interference cancellation capability, a first data amount related to the uplink signal, and a second data amount related to the downlink signal.

Alternatively, the processor is configured to adjust a driving mode of a device connected to the UE based on the first time resource period.

### Advantageous Effects

According to various embodiments of the present disclosure, a first time resource period for performing full-duplex radio (FDR) and a second time resource period for performing half-duplex radio may be allocated separately, and a modulation and coding scheme (MCS) related to the first time resource period and an MCS related to the second time resource period may be allocated separately, thereby effectively improving the efficiency and data throughput of an FDR system.

According to various embodiments, a terminal may perform quick beam transmission, beam acquisition, and beam tracking by performing cooperative beam sweeping with other terminals in a group based on group information or cooperation information.

### DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 illustrates the structure of an LTE system to which embodiment(s) are applicable.

FIG. 2 illustrates a user-plane radio protocol architecture to which embodiment(s) are applicable.

FIG. 3 illustrates a control-plane radio protocol architecture to which embodiment(s) are applicable.

FIG. 4 illustrates the structure of an NR system to which embodiment(s) are applicable.

FIG. 5 illustrates functional split between an NG-RAN and a 5GC to which embodiment(s) are applicable.

FIG. 6 illustrates the structure of an NR radio frame to which embodiment(s) are applicable.

FIG. 7 illustrates the slot structure of an NR frame to which embodiment(s) are applicable.

FIG. 8 illustrates a radio protocol architecture for SL communication.

FIG. 9 illustrates a structure of a self-contained slot.

FIG. 10 illustrates an ACK/NACK transmission process.

FIG. 11 illustrates an exemplary PUSCH transmission process.

FIG. 12 illustrates exemplary multiplexing of UCI in a PUSCH.

FIGS. 13 and 14 are diagrams for explaining methods of canceling a self-interference signal in a full-duplex radio (FDR) system.

FIGS. 15 and 16 are diagrams for explaining methods of allocating transmission and reception resources in a communication system.

FIG. 17 is a diagram for explaining a method in which a base station (BS) allocates a different length of time resource to a user equipment (UE) based on the amount of uplink (UL) signal data and the amount of downlink (DL) signal data in any time period.

FIG. 18 is a diagram for explaining resource use efficiency and resource increase according to a proposed resource allocation method.

FIG. 19 is a diagram for explaining a method of allocating time resources for DL and UL based on an offset.

FIG. 20 is a diagram for explaining a method in which a UE receives allocation of resources for FDR in an FDR system.

FIG. 21 illustrates a communication system applied to the present disclosure;

FIG. 22 illustrates wireless devices applicable to the present disclosure.

FIG. 23 illustrates another example of a wireless device to which the present disclosure is applied. The wireless device may be implemented in various forms according to use-examples/services.

FIG. 24 illustrates a hand-held device applied to the present disclosure;

FIG. 25 illustrates a vehicle or an autonomous driving vehicle applied to the present disclosure.

### BEST MODE

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR can utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto.

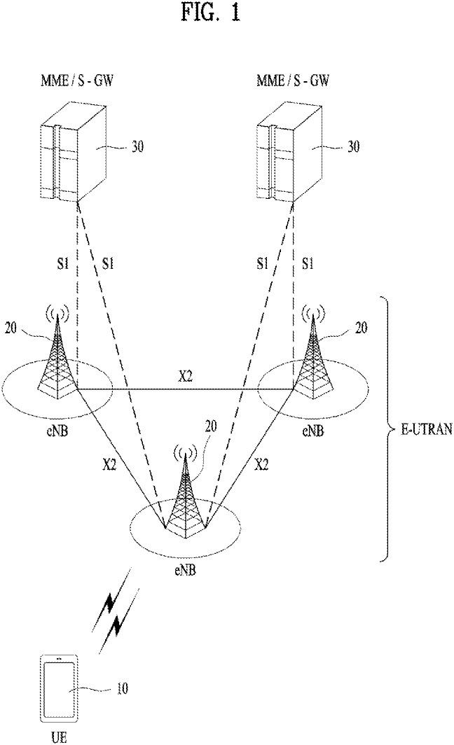

FIG. 1 illustrates the structure of an LTE system to which the present disclosure is applicable. This may also be called an evolved UMTS terrestrial radio access network (E-UTRAN) or LTE/LTE-A system.

Referring to FIG. 1, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point. [61] eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

FIG. 2 illustrates a user-plane radio protocol architecture to which the present disclosure is applicable.

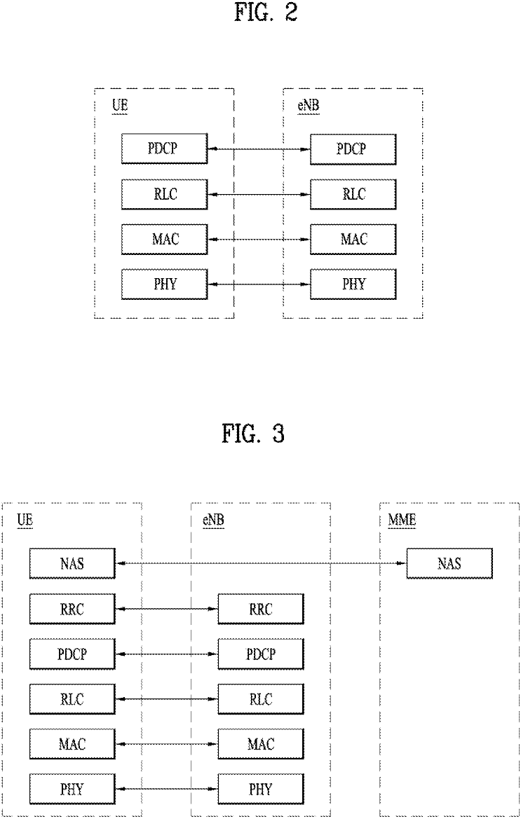

FIG. 3 illustrates a control-plane radio protocol architecture to which the present disclosure is applicable. A user plane is a protocol stack for user data transmission, and a control plane is a protocol stack for control signal transmission.

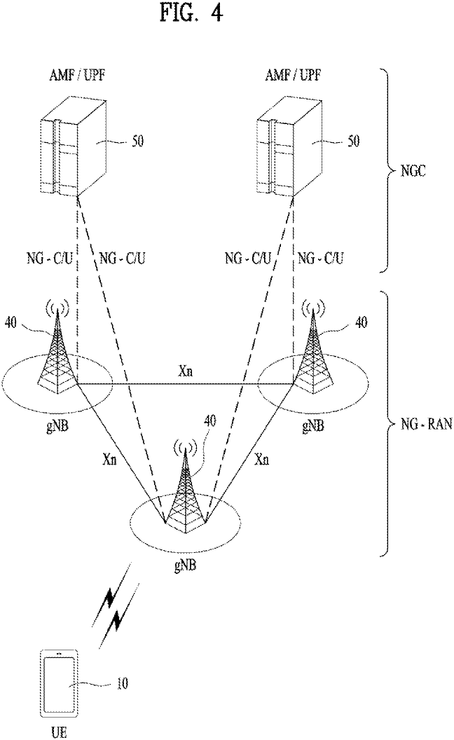

Referring to FIGS. 3 and 4, the PHY layer provides an information transfer service to its higher layer on physical channels. The PHY layer is connected to the medium access control (MAC) layer through transport channels and data is transferred between the MAC layer and the PHY layer on the transport channels. The transport channels are divided according to features with which data is transmitted via a radio interface.

Data is transmitted on physical channels between different PHY layers, that is, the PHY layers of a transmitter and a receiver. The physical channels may be modulated in orthogonal frequency division multiplexing (OFDM) and use time and frequencies as radio resources.

The MAC layer provides services to a higher layer, radio link control (RLC) on logical channels. The MAC layer provides a function of mapping from a plurality of logical channels to a plurality of transport channels. Further, the MAC layer provides a logical channel multiplexing function by mapping a plurality of logical channels to a single transport channel. A MAC sublayer provides a data transmission service on the logical channels.

The RLC layer performs concatenation, segmentation, and reassembly for RLC serving data units (SDUs). In order to guarantee various quality of service (QoS) requirements of each radio bearer (RB), the RLC layer provides three operation modes, transparent mode (TM), unacknowledged mode (UM), and acknowledged Mode (AM). An AM RLC provides error correction through automatic repeat request (ARQ).

The RRC layer is defined only in the control plane and controls logical channels, transport channels, and physical channels in relation to configuration, reconfiguration, and release of RBs. An RB refers to a logical path provided by L1 (the PHY layer) and L2 (the MAC layer, the RLC layer, and the packet data convergence protocol (PDCP) layer), for data transmission between the UE and the network.

The user-plane functions of the PDCP layer include user data transmission, header compression, and ciphering. The control-plane functions of the PDCP layer include control-plane data transmission and ciphering/integrity protection.

RB establishment amounts to a process of defining radio protocol layers and channel features and configuring specific parameters and operation methods in order to provide a specific service. RBs may be classified into two types, signaling radio bearer (SRB) and data radio bearer (DRB). The SRB is used as a path in which an RRC message is transmitted on the control plane, whereas the DRB is used as a path in which user data is transmitted on the user plane.

Once an RRC connection is established between the RRC layer of the UE and the RRC layer of the E-UTRAN, the UE is placed in RRC_CONNECTED state, and otherwise, the UE is placed in RRC_IDLE state. In NR, RRC_INACTIVE state is additionally defined. A UE in the RRC_INACTIVE state may maintain a connection to a core network, while releasing a connection from an eNB.

DL transport channels carrying data from the network to the UE include a broadcast channel (BCH) on which system information is transmitted and a DL shared channel (DL SCH) on which user traffic or a control message is transmitted. Traffic or a control message of a DL multicast or broadcast service may be transmitted on the DL-SCH or a DL multicast channel (DL MCH). UL transport channels carrying data from the UE to the network include a random access channel (RACH) on which an initial control message is transmitted and an UL shared channel (UL SCH) on which user traffic or a control message is transmitted.

The logical channels which are above and mapped to the transport channels include a broadcast control channel (BCCH), a paging control channel (PCCH), a common control channel (CCCH), a multicast control channel (MCCH), and a multicast traffic channel (MTCH).

A physical channel includes a plurality of OFDM symbols in the time domain by a plurality of subcarriers in the frequency domain. One subframe includes a plurality of OFDM symbols in the time domain. An RB is a resource allocation unit defined by a plurality of OFDM symbols by a plurality of subcarriers. Further, each subframe may use specific subcarriers of specific OFDM symbols (e.g., the first OFDM symbol) in a corresponding subframe for a physical DL control channel (PDCCH), that is, an L1/L2 control channel. A transmission time interval (TTI) is a unit time for subframe transmission.

FIG. 4 illustrates the structure of a NR system to which the present disclosure is applicable.

Referring to FIG. 4, a next generation radio access network (NG-RAN) may include a next generation Node B (gNB) and/or an eNB, which provides user-plane and control-plane protocol termination to a UE. In FIG. 4, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

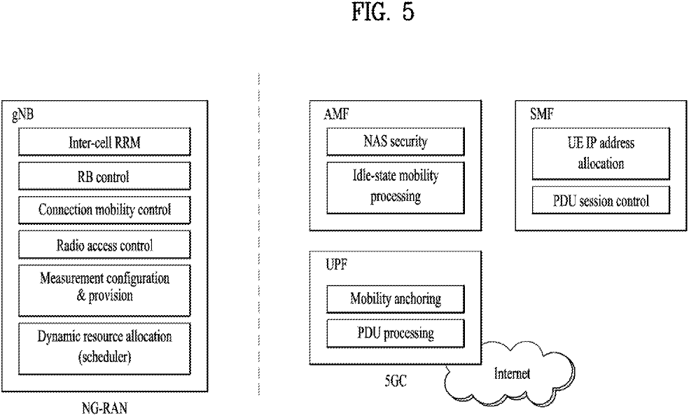

FIG. 5 illustrates functional split between the NG-RAN and the 5GC to which the present disclosure is applicable.

Referring to FIG. 5, a gNB may provide functions including inter-cell radio resource management (RRM), radio admission control, measurement configuration and provision, and dynamic resource allocation. The AMF may provide functions such as non-access stratum (NAS) security and idle-state mobility processing. The UPF may provide functions including mobility anchoring and protocol data unit (PDU) processing. A session management function (SMF) may provide functions including UE Internet protocol (IP) address allocation and PDU session control.

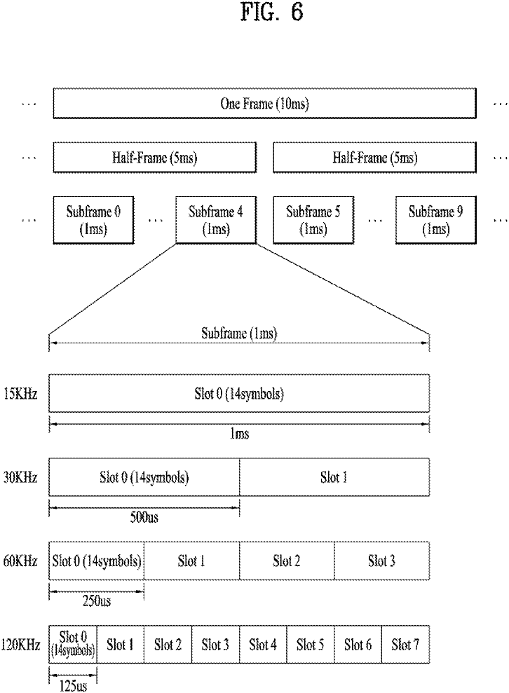

FIG. 6 illustrates the structure of a NR radio frame to which the present disclosure is applicable.

Referring to FIG. 6, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration µ in the NCP case.

Table 1

| SCS (15*2u) | N^{slot}_{symb} | N^{frame,u}ₛₗₒₜ | N^{subframe,u}ₛₗₒₜ |
|---|---|---|---|
| 15 KHz (u=0) | 14 | 10 | 1 |
| 30 KHz (u=1) | 14 | 20 | 2 |
| 60 KHz (u=2) | 14 | 40 | 4 |
| 120 KHz (u=3) | 14 | 80 | 8 |
| 240 KHz (u=4) | 14 | 160 | 16 |

Table 2 below lists the number of symbols per slot, the number of slots per frame, and the number of slots per subframe according to an SCS in the ECP case.

Table 2

| SCS (15*2^{∧}u) | N^{slot}_{symb} | N^{frame,u}ₛₗₒₜ | N^{subframe,u}ₛₗₒₜ |
|---|---|---|---|
| 60 KHz (u=2) | 12 | 40 | 4 |

In the NR system, different OFDM(A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

Table 3

| | | |
|---|---|---|
| Frequency Range designation | Corresponding frequency range | Subcarrier Spacing (SCS) |
| FR1 | 450 MHz — 6000 MHz | 15, 30, 60 kHz |
| FR2 | 24250 MHz — 52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

Table 4

| | | |
|---|---|---|
| Frequency Range designation | Corresponding frequency range | Subcarrier Spacing (SCS) |
| FR1 | 410 MHz — 7125 MHz | 15, 30, 60 kHz |
| FR2 | 24250 MHz — 52600 MHz | 60, 120, 240 kHz |

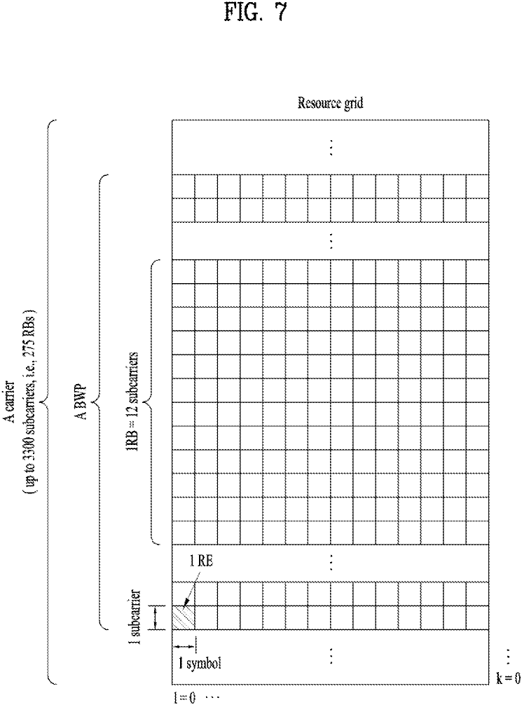

FIG. 7 illustrates the slot structure of a NR frame to which the present disclosure is applicable.

Referring to FIG. 7, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P)RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Hereinafter, V2X or sidelink (SL) communication will be described.

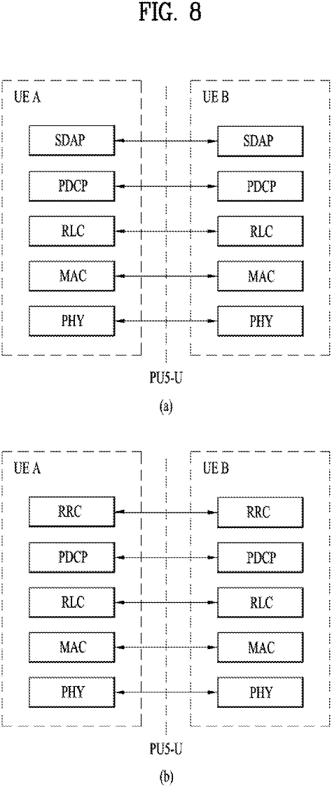

FIG. 8 illustrates a radio protocol architecture for SL communication. Specifically, FIG. 8-(a) shows a user plane protocol stack of NR, and FIG. 8-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre)set sidelink BWP (SL BWP). For example, the bandwidth of the S-SSB may be 11 resource blocks (RBs). For example, the PSBCH may span 11 RBs. The frequency position of the S-SSB may be (pre)set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

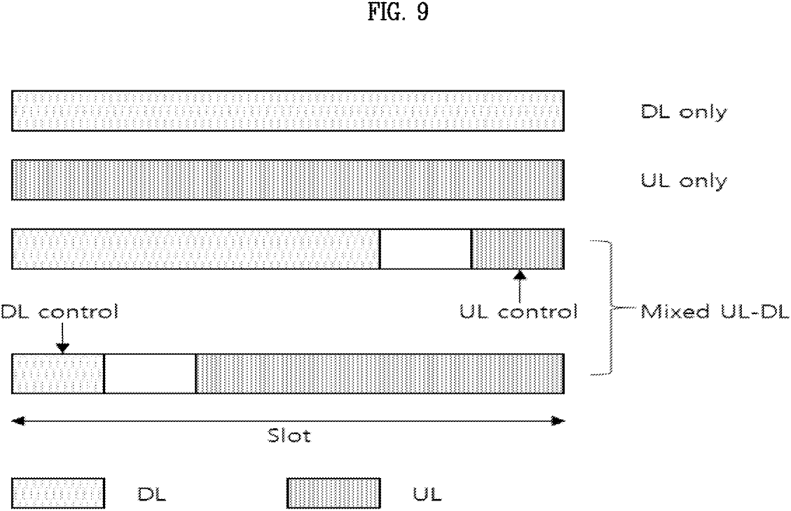

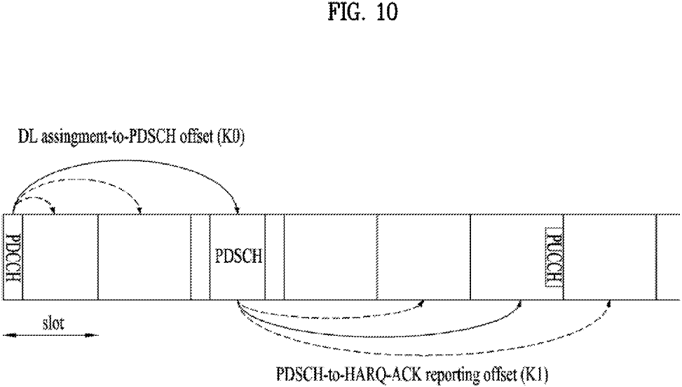

FIG. 9 illustrates a structure of a self-contained slot.

In the NR system, a frame has a self-contained structure in which a DL control channel, DL or UL data, a UL control channel, and the like may all be contained in one slot. For example, the first N symbols (hereinafter, DL control region) in the slot may be used to transmit a DL control channel, and the last M symbols (hereinafter, UL control region) in the slot may be used to transmit a UL control channel. N and M are integers greater than or equal to 0. A resource region (hereinafter, a data region) that is between the DL control region and the UL control region may be used for DL data transmission or UL data transmission. For example, the following configuration may be considered. Respective sections are listed in a temporal order.
1. DL only configuration
2. UL only configuration
3. Mixed UL—DL configuration
DL region + Guard period (GP) + UL control region
DL control region + GP + UL region
* DL region: (i) DL data region, (ii) DL control region + DL data region
* UL region: (i) UL data region, (ii) UL data region + UL control region

The PDCCH may be transmitted in the DL control region, and the PDSCH may be transmitted in the DL data region. The PUCCH may be transmitted in the UL control region, and the PUSCH may be transmitted in the UL data region. The GP provides a time gap in the process of the UE switching from the transmission mode to the reception mode or from the reception mode to the transmission mode. Some symbols at the time of switching from DL to UL within a subframe may be configured as the GP.

In the present disclosure, a base station (BS) may be, for example, a gNode B (gNB).

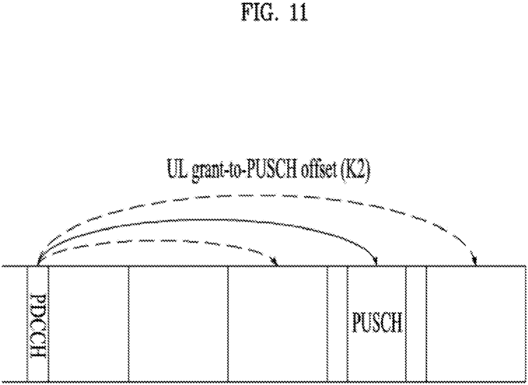

FIG. 10 illustrates an ACK/NACK transmission process.

Referring to FIG. 10, the UE may detect a PDCCH in slot #n. The PDCCH includes DL scheduling information (e.g., DCI format 1_0 or DCI format 1_1). The PDCCH indicates a DL assignment-to-PDSCH offset, K0 and a PDSCH-to-HARQ-ACK reporting offset, K1. For example, DCI format 1_0 or DCI format 1_1 may include the following information.
Frequency domain resource assignment: Indicates an RB set assigned to a PDSCH.
Time domain resource assignment: Indicates K0 and the starting position (e.g. OFDM symbol index) and length (e.g. the number of OFDM symbols) of the PDSCH in a slot.
PDSCH-to-HARQ_feedback timing indicator: Indicates K1.

After receiving a PDSCH in slot #(n+K0) according to the scheduling information of slot #n, the UE may transmit UCI on a PUCCH in slot #(n+K1). The UCI includes an HARQ-ACK response to the PDSCH. In the case where the PDSCH is configured to carry one TB at maximum, the HARQ-ACK response may be configured in one bit. In the case where the PDSCH is configured to carry up to two TBs, the HARQ-ACK response may be configured in two bits if spatial bundling is not configured and in one bit if spatial bundling is configured. When slot #(n+K1) is designated as an HARQ-ACK transmission timing for a plurality of PDSCHs, UCI transmitted in slot #(n+K1) includes HARQ-ACK responses to the plurality of PDSCHs.

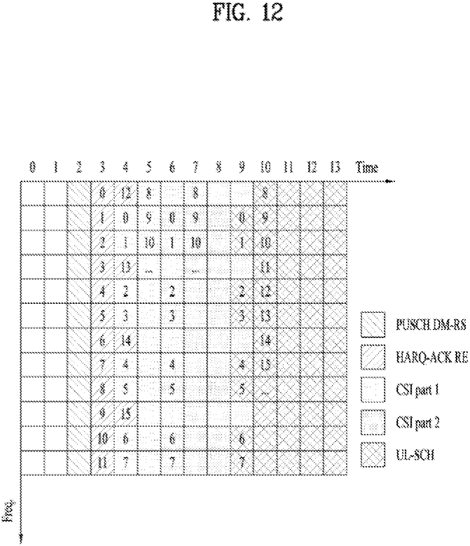

FIG. 11 illustrates an exemplary PUSCH transmission process.

Referring to FIG. 11, the UE may detect a PDCCH in slot #n. The PDCCH may include UL scheduling information (e.g., DCI format 0_0 or DCI format 0_1). DCI format 0_0 and DCI format 0_1 may include the following information.

- Frequency domain resource assignment: Indicates an RB set allocated to a PUSCH.

- Time domain resource assignment: Specifies a slot offset K2 indicating the starting position (e.g., symbol index) and length (e.g., the number of OFDM symbols) of the PUSCH in a slot. The starting symbol and length of the PUSCH may be indicated by a start and length indicator value (SLIV), or separately.

The UE may then transmit a PUSCH in slot #(n+K2) according to the scheduling information in slot #n. The PUSCH includes a UL-SCH TB.

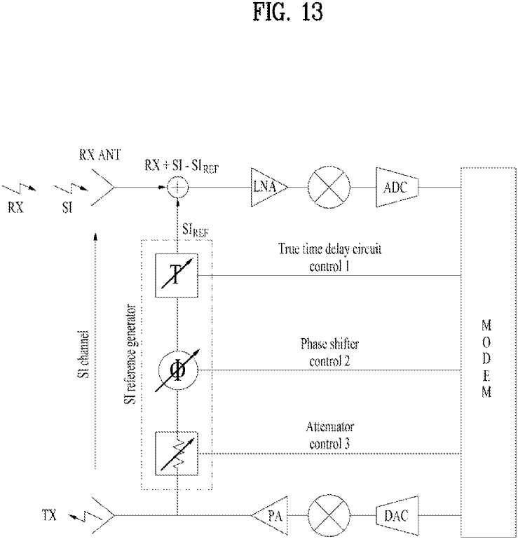

FIG. 12 illustrates exemplary multiplexing of UCI in a PUSCH.

Referring to FIG. 12, if a plurality of PUCCH resources overlap with a PUSCH resource in a slot and a PUCCH-PUSCH simultaneous transmission is not configured in the slot, UCI may be transmitted on a PUSCH (UCI piggyback or PUSCH piggyback), as illustrated. In the illustrated case of FIG. 8, an HARQ-ACK and CSI are carried in a PUSCH resource.

### Full-Duplex Radio (FDR)

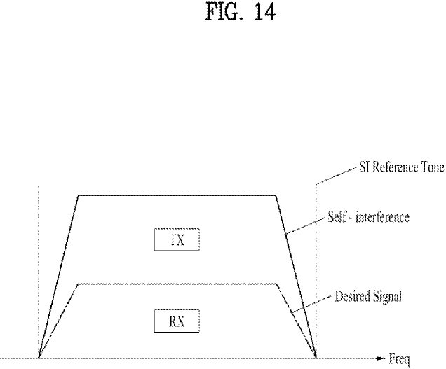

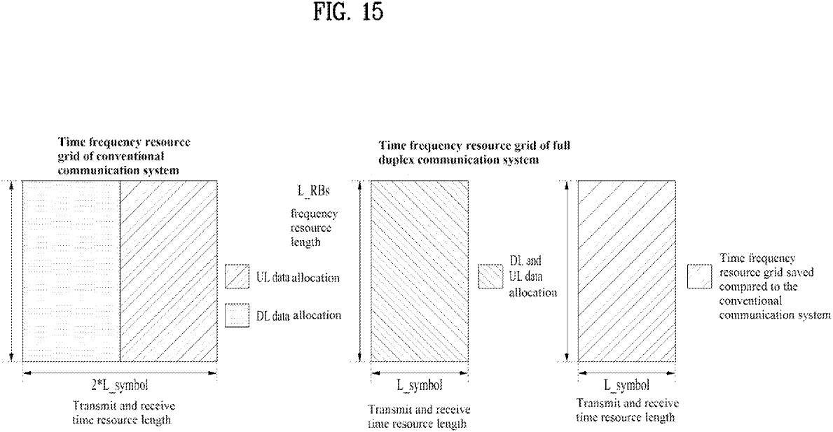

FIGS. 13 and 14 are diagrams for explaining methods of canceling a self-interference signal in an FDR system.

FIG. 13 shows a method of creating a duplicate signal (i.e., self-interference (SI) reference signal) identical to an SI signal and adding the duplicate signal before a low noise amplifier (LNA), which is the beginning of a receiver (RX) chain, in order to remove the SI signal in an FDR system. In this case, the SI reference signal may be a signal obtain by passing a part of a transmitter (TX) signal as an input into an SI reference generator, which consists of an attenuator, a phase shifter, and a true time delay circuit, in order to mimic an SI channel. In addition, a channel on which the SI signal is received may be separately estimated to allow the SI reference generator to mimic the SI channel. In other words, the SI signal may be cancelled by controlling analog elements (e.g., attenuator, phase shifter, true time delay circuit) based on the estimated channel.

Referring to FIG. 14, in the prior art, a tone for SI signal channel estimation may be included at both ends of a communication channel band (guard band), and an SI reference generator may be controlled such that the corresponding estimation tone is reduced according to an adaptive feedback algorithm. In this case, a desired signal from which SI is cancelled may be stably received.

On the other hand, in the legacy communication system, frequency-time resources for transmitting transmission or reception data are allocated to a UE without considering the characteristics of the FDR system. That is, time-frequency resources required for transmission are allocated to an arbitrary UE according to a transmission request from the arbitrary UE. Alternatively, time-frequency resources required for reception are allocated to the arbitrary UE according to a reception request from the arbitrary UE, separately from the time-frequency resources required for transmission.

However, since transmission and reception are simultaneously performed in the FDR system, time-frequency resources do not need to be allocated for each of the transmission and reception. Therefore, there is a need for a new resource allocation method for more efficient use of limited time-frequency resources in the FDR system. That is, the new resource allocation method may increase the overall throughput of the FDR system and also improve the efficiency thereof.

Hereinafter, a method of redefining the structure of downlink control information (DCI) to increase the efficiency of the FDR system while maintaining compatibility with the legacy communication system and a method of allocating efficient time-frequency resources based on an RRC message will be described.

### Efficient Time Frequency Resource Allocation Method in FDR System

The present disclosure relates to self-interference cancellation (SIC) in an FDR system. The FDR system uses the same frequency band and increases the frequency efficiency up to two times compared to the legacy FDD/TDD system. In other words, the FDR system is a communication system capable of simultaneously transmitting and receiving in the same frequency-time region. Meanwhile, SI may occur while transmission and reception are simultaneously performed in the same frequency band, and thus it is necessary to remove or minimize the SI.

In the legacy communication system, the UE may be allocated time-frequency resources for transmission or reception from the BS based on DCI received from the BS. On the other hand, in the FDR system, since the UE is capable of performing reception and transmission at the same time, the UE may use time-frequency resources allocated from the BS for both transmission and reception. In other words, in the FDR system, the BS may not need to allocate resources for transmission and resources for reception separately.

Accordingly, in the FDR system, resource allocation for transmission and resource allocation for reception may be performed with one piece of DCI, unlike the legacy wireless communication system where UL DCI and DL DCI are separated. In consideration of this point, the present disclosure may allocate time-frequency resources for transmission and reception more efficiently based on an extended information field. In addition, considering that the amount of data received and transmitted within a specific time is generally not the same due to the nature of the wireless communication system, the present disclosure proposes a new time-frequency resource allocation method for transmission and reception based on the amount of transmission and reception data.

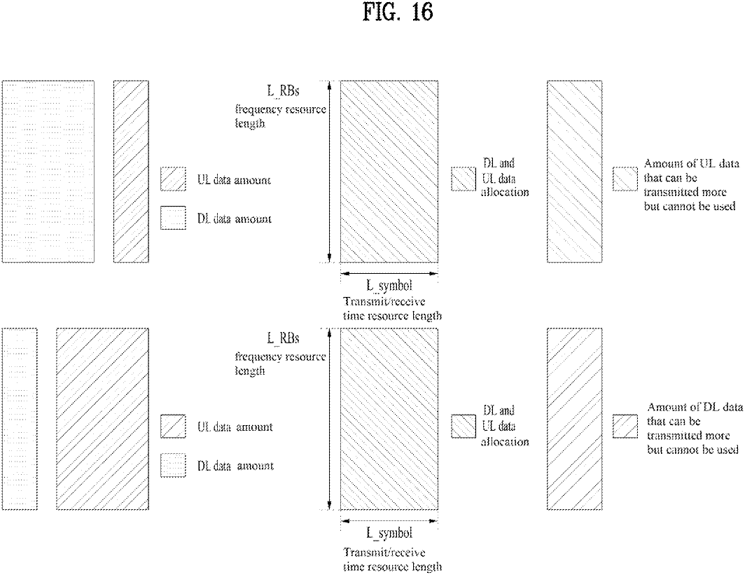

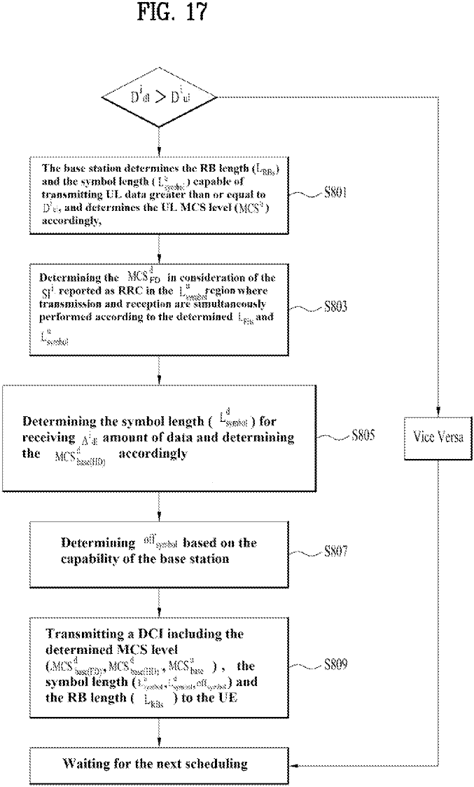

FIGS. 15 and 16 are diagrams for explaining methods of allocating transmission and reception resources in a communication system.

FIG. 15 shows a method of allocating resources for transmission and reception in the legacy communication system and a method of allocating resources for transmission and reception in the FDR system when any one UE capable of FDR communication in any specific slot t (or predetermined time resource period) has the same amount of incoming and outgoing data. The UE capable of FDR communication may perform transmission and reception on the same time and frequency resources as shown in FIG. 15. Accordingly, the FDR system may theoretically have twice the channel capacity compared to the legacy communication system.

However, in most cases, the amount of outgoing data and the amount of incoming data in the specific slot t (or predetermined time resource period) may not be the same as shown in FIG. 16. In other words, the amount of incoming data in the specific slot t (or predetermined time resource period) may be greater or less than the amount of outgoing data. In this case, resources for transmission and reception may be allocated based on the larger one of the amount of outgoing data (or the amount of UL data) and the amount of incoming data (or the amount of DL data). As a result, a problem may occur in that unnecessary resources are additionally allocated to a signal with a relatively small amount of data. That is, when a DL signal and a UL signal have different amounts of data for a prescribed period of time, it may cause a problem that unnecessary resources are allocated to a signal with a relatively small amount of data among the DL signal and the UL signal.

Thus, a new time-frequency resource allocation method to minimize the amount of incoming or outgoing data unavailable in any specific slot t (or predetermined time resource period) or in any time period needs to be applied to the FDR system. Accordingly, the present disclosure proposes a new resource allocation method based on different amount of data between DL and UL signals in order to effectively increase the efficiency and data throughput of the FDR system

Hereinafter, there is proposed a method of allocating a different length of time resources to a UE based on the amount of incoming and outgoing data (or the amount of UL signal data and the amount of DL signal data) in any time slot t (or predetermined time resource period) or in any time period and/or a method of allocating a different modulation and coding scheme (MCS) to a UE based on the amount of incoming and outgoing data (or the amount of UL signal data and the amount of DL signal data). Such methods may be performed based on an extended information field of DCI and a new RRC message.

FIG. 17 is a diagram for explaining a method in which a BS allocates a different length of time resource to a UE based on the amount of UL signal data and the amount of DL signal data in any time period.

In the FDR transmission communication system, the UE may transmit SIⁱ, which is the capability of SIC, to the BS through RRC signaling, and the BS may calculate the amount of DL data ₍Dⁱdl₎ and the amount of UL data (Dⁱul) for the UE within a predetermined time period based on SIⁱ. In this case, the BS may configure the same length of frequency resource for transmission and reception. The reason for this is that in the FDR system, the efficiency of SIC is maximized when the UE is allocated the same length of frequency resource for DL and UL signals as a resource for simultaneously performing transmission and reception (FDR resource).

Referring to FIG. 17, when the amount of DL data is greater than the amount of UL data, the BS may determine a symbol length for UL data Lᵤ, a frequency region length L_{RBs}, and an MCS for UL data MCS^{u} (S801). Here, the symbol length Lᵤ is the length of a time resource determined based on the number of RBs capable of handling the amount of UL data, which may be a time period corresponding to an FDR operation period required for the UE to perform UL transmission and DL reception simultaneously. In addition, MCS^{u} denotes the MCS level used by the UE for a UL signal.

The BS may determine an MCS for DL (MCS^{d}FD) for the symbol length (Lᵤ) for UL data or for a period in which DL and UL signals are transmitted and received in FDR mode. The BS may determine MCS^{d}_{FD} for Lᵤ (or L_{RBS}) (or maximum transmittable value for Lᵤ) based on SIⁱ and MCS^{u} (S803). Alternatively, the BS may determine MCS^{d}_{FD} based on SINR_{FD}, which is calculated based on reference signal received power (RSRP), SIⁱ, and TP (transmit power) that denotes a transmit power level reported by the UE. Specifically, the BS may calculate the SINR_{FD} according to Equation 1 below and determine MCS^{d}_{FD} based on calculated SINR_{FD}, that is, using a predetermined correspondence table based on SINR (Signal to Interference Noise Ratio) and THD (threshold).

$$S I N {R}_{F D} = \frac{R S R P \times S I N R}{R S R P + \left(T P \times S {I}^{i}\right) \times S I N R}$$

Alternatively, Lᵤ may be an FDR time resource on which signal transmission and reception are performed, and the FDR time resource may be defined as a first time resource period.

Next, the BS may determine a symbol length (L_{d}) for the amount of remaining DL data except for the amount of data capable of being transmitted in the Lᵤ symbol (or the amount of data calculated based on MCS^{d}_{FD}, L_{RBs}, and Lᵤ) among the total amount of DL data and an MCS for L_{d}, MCS^{d}_{HD}. Here, L_{d} may be a time period corresponding to a half-duplex operation period in which the UE performs DL reception only. In this case, a determination algorithm of the legacy communication system may be used for L_{d} and MCS^{d}_{HD} in the same way (S805). For example, L_{d} and MCS^{d}_{HD} may be determined according to an existing algorithm of the legacy half-duplex radio (HDR) system.

Alternatively, L_{d} may be an HDR resource on which only a DL signal is received, and such an HDR time resource may be defined as a second time resource. That is, the BS may allocate a predetermined time resource period (or any time resource period) by dividing the time resource period into a first time resource period in which signal transmission and reception are performed simultaneously and a second time resource period in which either signal transmission or signal reception is performed.

Alternatively, the BS may determine an offset between the first symbol (Lᵤ) and the second symbol (L_{d}). The offset may be determined by

$$O f {f}_{s y m b o l} ≡ s t a r t \_ o f \_ {L}_{s y m b o l}^{d} - s t a r t \_ o f \_ {L}_{s y m b o l}^{u}$$

(S807). In addition, Oƒƒ_{symbol} may be freely adjusted by the BS according to the capability of the BS.

The BS may transmit information on the determined MCS levels: MCS^{d}_{FD} , MCS^{d}_{HD}, and MCS^{u}, and/or L_{d}, Lᵤ, L_{RBs}, and offset to the UE in DCI (S809).

On the other hand, when the amount of DL data is smaller than the amount of UL data, the BS may operate in reverse as follows.

Specifically, the BS may determine L_{d} (or first time resource period), which is a symbol length for DL data, L_{RBs}, which is a frequency region length for the DL data, and MCS_{d}, which is an MCS for the DL data. The BS may determine MCS_{uFD}, which is an MCS for UL data in the L_{d} symbol(s), based on SINR_{FD} calculated according to Equation 1. The BS may determine a symbol length Lᵤ (or second time resource period) for the amount of remaining UL data except for the amount of data corresponding to L_{d} among the total amount of UL data and MCS_{uHD} for UL in Lᵤ. Here, Lᵤ and MSC_{uHD} may be determined according to an existing algorithm of the legacy HDR system. The BS may transmit information on the determined MCS levels: MCS_{d}, MCS_{uHD}, and MCS_{uFD}, and/or L_{d}, Lᵤ, L_{RBs}, and an offset to the UE in DCI.

On the other hand, L_{d} may be a symbol length except Lᵤ or a predetermined time resource period. Hereinafter, a period corresponding to the predetermined time resource period may be defined as L_{da}.

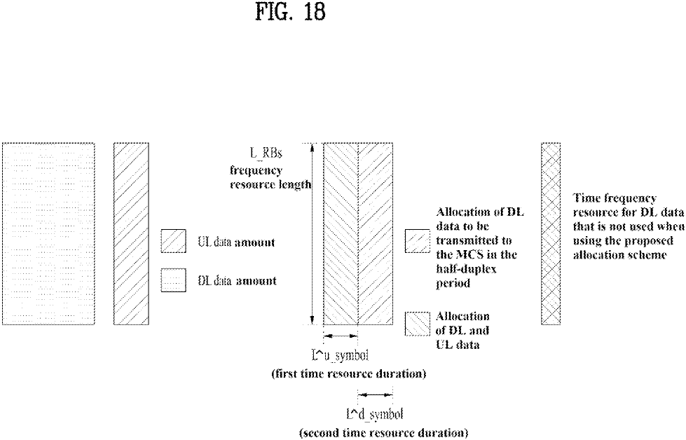

FIG. 18 is a diagram for explaining resource use efficiency and resource increase according to the proposed resource allocation method.

Referring to FIG. 18, when time frequency resources are allocated according to the above-described proposed method, resource utilization efficiency and data throughput may be improved compared to the resource allocation method in FIG. 15. On the other hand, if the amount of UL signal data is large, the opposite may be valid.

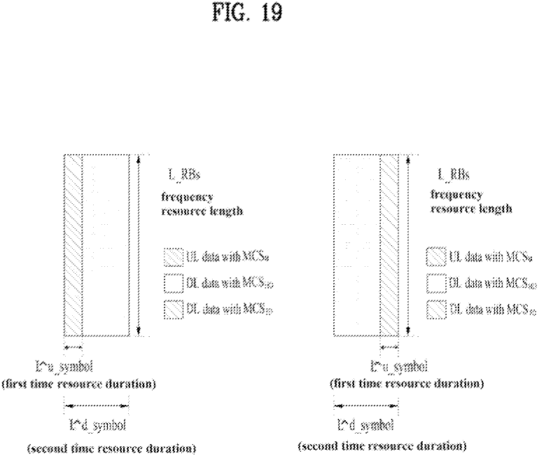

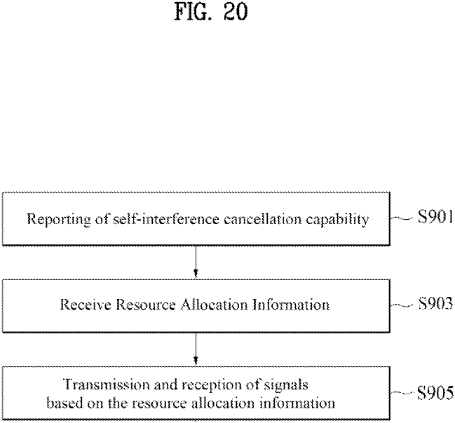

FIG. 19 is a diagram for explaining a method of allocating time resources for DL and UL based on an offset.

Referring to FIG. 19, the offset may be set to zero. In this case, an overlapping part (FDR period) between a period in which the UE performs UL transmission (Lᵤ or a first time resource period) and a period in which the UE performs DL reception (L_{da} or a predetermined time resource period) may start first, and an HDR period in which only DL reception is performed may be located after the Lᵤ period. In other words, the first time resource period may be allocated before the second time resource period. For example, a timing or symbol at which the first time resource period starts may be the same as a timing or symbol at which the preconfigured time resource period starts.

Referring to FIG. 19, the offset may be preset to L_{da} - Lᵤ (or a difference between the second time resource period and the first time resource period). In this case, the period in which only DL reception is performed may start earlier than the overlapping period (FDR period) between the period in which UL transmission is performed (Lᵤ) and the predetermined time resource period (L_{da}). Here, the time at which the FDR period ends may be the same as the time at which L_{da} ends.

As described above, the BS mama efficiently adjust the position of the FDR period based on the offset.

FIG. 20 is a diagram for explaining a method in which a UE receives allocation of resources for FDR in an FDR system.

Referring to FIG. 20, the UE may report the SIC capability to the BS to be allocated resources related to FDR communication from the BS (S901). The SIC capability is related to an ability to simultaneously perform DL signal reception and UL signal transmission on the same resource. Alternatively, the UE may report in advance to the BS whether the UE supports the FDR communication.

Alternatively, the UE may transmit at least one of a buffer status report (BSR), a channel quality indicator (CQI), and the SIC capability to the BS in order to be granted or allocated the resources related to FDR communication. Specifically, the UE may transmit a signal including the BSR related to the amount of UL signal data to the BS in order to be allocated resources for transmitting its UL signal. In addition, the UE may transmit CQI information related to its channel state to the BS. The UE may report the SIC capability to the BS through RRC signaling.

Next, the UE may receive resource allocation information about a predetermined time resource period from the BS (S903). The predetermined time resource period may be divided into a first time resource period in which UL transmission and DL reception are performed simultaneously in the same frequency band based on FDR communication and a second time resource period in which only one signal is received or transmitted based on HDR communication. That is, the UE may receive the resource allocation information on the predetermined time resource period, which is divided into the time resource period based on FDR communication and the time resource period based on HDR communication. Here, each of the first time resource period and the second time resource period may include a plurality of consecutive OFDM symbols in the frequency domain, and the first time resource period may be continuous with the second time resource period in the frequency domain. Meanwhile, the predetermined time resource period may be equivalent to the size of a time resource scheduled or granted to the UE by the BS.

Each of the first time resource period and the second time resource period may be determined by the BS based on the SIC capability reported to the BS, the amount of UL signal data (or the amount of first data), and the amount of DL signal data to be transmitted by the BS to the UE (or the amount of second data). In other words, the BS can determine the first time resource period for FDR and the second time resource period for HDR in consideration of the SI capability of the UE, the amount of UL signal data to be transmitted by the UE, and the amount of DL signal data. Then, the BS may transmit allocation information about the determined time resource period to the UE. Each of the first time resource period and the second time resource period may include one or more consecutive OFDM symbols.

Alternatively, the first time resource period may be determined based on at least one of the SIC capability, the amount of first data, and the amount of second data. The BS may estimate the amount of data that the UE is capable of transmitting and receiving in FDR mode based on the reported SIC capability and then determine the first time resource period based on a smaller one of the amount of first data and the amount of second data. For example, the BS may determine the maximum size of the first time resource period based on the SIC capability. Then, the BS may determine the size of the first time resource period to match with the size of time resources capable of transmitting the smaller one of the amount of first data and the amount of second data within the maximum size.

In addition, the second time resource period may be determined based on a difference between the amount of first data and the amount of second data. For example, the second time resource period may be determined such that it is equivalent to the size of time resources capable of transmitting a difference between the amount of first data and the amount of second data or the size of time resources in an RB capable of transmitting the difference amount.

Alternatively, the resource allocation information may further include information on an offset for specifying the first time resource period. The offset may be a difference between the start timing or start OFDM symbol index of the first time resource period and the start timing or start OFDM symbol index of the predetermined time resource period. In this case, the UE may recognize whether the first time resource period is located before or after the predetermined time resource period based on the offset information included in the resource allocation information. For example, if the offset is 0, the first time resource period may be earlier than the second time resource period, and the start timing or start OFDM symbol index thereof may correspond to that of the predetermined time resource period. Alternatively, when the offset is greater than 0, the second time resource period may be allocated prior to the first time resource period.

Alternatively, the resource allocation information may be transmitted by the BS to the UE in UL DCI, DL DCI, or separate DCI. Alternatively, the resource allocation information may be transmitted by the BS to the UE in DCI for FDR communication, which is defined separately.

Alternatively, the resource allocation information may include MCS allocation information, which is divided into a first MCS and a second MCS for any one of the UL signal and the DL signal depending on the amount of first data and the amount of second data. Specifically, for the DL signal, if the amount of second data is greater than the amount of first data, the first MCS may be applied to the first time resource period, and the second MCS may be applied to the second time resource period. For the UL signal, if the amount of second data is less than the amount of first data, the first MCS may be applied to the first time resource period, and the second MCS may be applied to the second time resource period.

On the other hand, if the amount of second data is greater than the amount of first data, the UL signal may be transmitted only in the first time resource period based on one MCS. If the amount of second data is smaller than the amount of first data, the DL signal may be transmitted only in the first time resource period based on one MCS.

Alternatively, MCS information on the UL signal and the DL signal may be included in the resource allocation information. The UE may obtain information on the first or second MCS for any one of the UL signal and the DL signal based on the resource allocation information and then obtain information on the other MCS for the remaining signals.

The first MCS may be determined based on RSRP, SINR, and the SIC capability measured by the UE. That is, the BS may determine the MCS for the first time resource period by additionally considering the SIC capability reported by the UE, unlike the conventional MCS determination.

Specifically, an MCS may be determined based on an SINR related to the UE. In particular, the first MCS may be determined based on SINR_{FD} in which the SIC capability is additionally reflected. SINR_{FD} may be determined according to Equation 1 above, and the SINR, TP, and RSRP may be obtained from a CQI measured and reported by the UE.

Next, the UE may transmit/receive a signal in the first time resource period and transmit or receive a signal in the second time resource based on the resource allocation information (S905). As described above, the UE may transmit the UL signal and receive the DL signal using the same frequency band in the first time resource period. In addition, the UE may either receive the DL signal or transmit the UL signal in the second time resource period. The UE may determine which is performed in the second time resource period based on the resource allocation information. For example, when the amount of UL signal data is greater than the amount of DL signal data, the UE may only transmit the UL signal in the second time resource period. When the amount of UL signal data is smaller than the amount of DL signal data, the UE may only receive the DL signal in the second time resource period.

Alternatively, the BS may receive a signal requesting scheduling of FDR-related resources from the UE. The scheduling request signal may include at least one of a BSR, the CQI, and the SIC capability.

Next, the BS may preconfigure an arbitrary time resource period based on the information included in the scheduling request signal. Then, the BS may determine the first time resource period in which the FDR operation is performed and the second time resource period in which the HDR operation is performed within the predetermined time resource period. The BS may determine the first time resource period based on the amount of UL signal data, the amount of DL signal data, and the SIC capability.

Alternatively, the BS may determine the first MCS for the determined first time resource period and the second MCS for the second time resource period for any one of the UL signal and the DL signal. In other words, the BS may determine different MCSs for the first time resource period in which the FDR operation is to be performed and the second time resource period in which the HDR operation is performed with respect to any one of the UL signal and the DL signal. The MCS for the first time resource period may be determined by Equation 1 as described above.

Alternatively, the BS may determine the offset for specifying the first time resource period. The offset may be defined as a difference between the start timing of the first time resource period and the start timing of the predetermined time resource period.

Next, the BS may transmit to the UE the resource allocation information including at least one of the first time resource period, the second time resource period, the MCS allocation information, and the offset. Here, the MCS allocation information is information about the first or second MCS for any one of the UL signal and the DL signal and the other MCS for the other signal.

Hereinafter, devices for performing the above-described proposed methods will be described in detail.

### Communication System Example to Which the Present Disclosure Is Applied

Although not limited thereto, various descriptions, functions, procedures, proposals, methods, and/or operational flow charts of the present disclosure disclosed in this document can be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

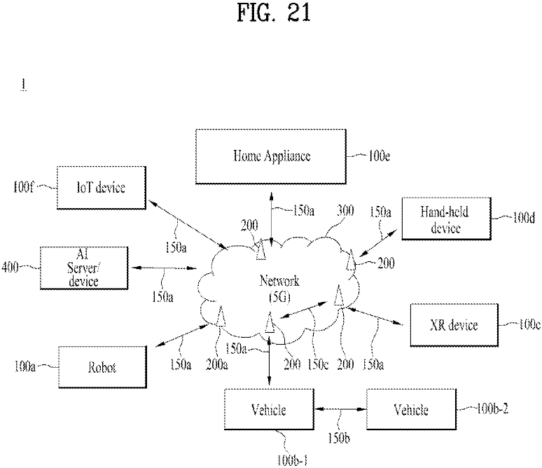

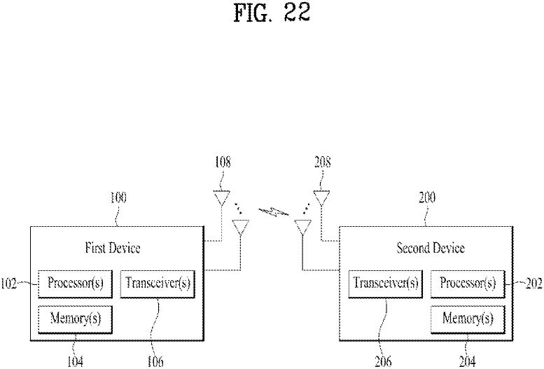

FIG. 21 illustrates a communication system applied to the present disclosure.

Referring to FIG. 21, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Examples of Wireless Devices to Which the Present Disclosure Is Applied

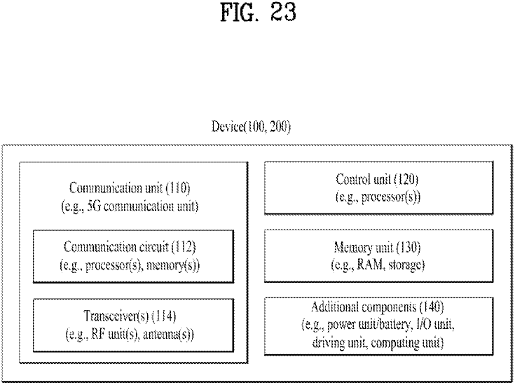

FIG. 22 illustrates a wireless device applicable to the present disclosure.

Referring to FIG. 22, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 21.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, the chipset may include the processor(s) 102 and memory(s) 104. The memory(s) 104 may include at least one program capable of performing operations related to the embodiments described with reference to FIGS. 14 to 20. The processor(s) 102 may receive allocation of resources related to FDR based on the at least one program stored in the memory(s) 104.

[200] The processor(s) 102 may control the RF transceiver(s) to report SIC capability to a BS. The processor(s) 102 may control the RF transceiver(s) to receive resource allocation information on a predetermined time period divided into a first time resource period and a second time resource period from the BS. In this case, the first time resource period may be a time resource period allocated to simultaneously perform transmission of a UL signal and reception of a DL signal in the same frequency band, and the second time resource period may be a time resource period allocated to perform either the transmission of the UL signal or the reception of the DL signal. In addition, the first time resource period and the second time resource period may be determined based on the SIC capability, the amount of first data related to the UL signal, and the amount of second data related to the DL signal.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

The processor(s) 202 of a BS may control the RF transceiver(s) to receive a report on SIC capability related to FDR from a UE. The processor(s) 202 may determine a first time resource period in which transmission of a UL signal and reception of a DL signal are simultaneously performed in the same frequency band for a predetermined time period and a second time resource period in which either the transmission of the UL signal or the reception of the DL signal is performed. The processor(s) 202 may control the RF transceiver(s) to transmit resource allocation information including information on the first time resource period and the second time resource period to the UE.

In another aspect of the present disclosure, there is provided a computer-readable storage medium having at least one computer program configured to cause at least one processor to perform operations. The operations may include: providing information on SIC capability to a BS; and receiving resource allocation information on a predetermined time period divided into a first time resource period and a second time resource period from the BS. In this case, the first time resource period may be a time resource period allocated to simultaneously perform transmission of a UL signal and reception of a DL signal in the same frequency band, and the second time resource period is a time resource period allocated to perform either the transmission of the UL signal or the reception of the DL signal. In addition, the first time resource period and the second time resource period may be determined based on the SIC capability, the amount of first data related to the UL signal, and the amount of second data related to the DL signal.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

### Examples of Wireless Devices to Which the Present Disclosure Is Applied

FIG. 23 illustrates another example of a wireless device applied to the present disclosure. The wireless device may be implemented in various forms according to a use-case/service (refer to FIG. 21)

Referring to FIG. 23, wireless devices 100 and 200 may correspond to the wireless devices 100 and 200 of FIG. 22 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 22. For example, the transceiver(s) 114 may include the one or more transceivers 106 and 206 and/or the one or more antennas 108 and 208 of FIG. 22. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 21), the vehicles (100b-1 and 100b-2 of FIG. 21), the XR device (100c of FIG. 21), the hand-held device (100d of FIG. 21), the home appliance (100e of FIG. 21), the IoT device (100f of FIG. 21), a digital broadcast terminal, a hologram device, a public safety device, an MTC device, a medicine device, a fintech device (or a finance device), a security device, a climate/environment device, the AI server/device (400 of FIG. 21), the BSs (200 of FIG. 21), a network node, etc. The wireless device may be used in a mobile or fixed place according to a use-example/service.

In FIG. 23, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 23 will be described in detail with reference to the drawings.

### Examples of Mobile Devices to Which the Present Disclosure Is Applied

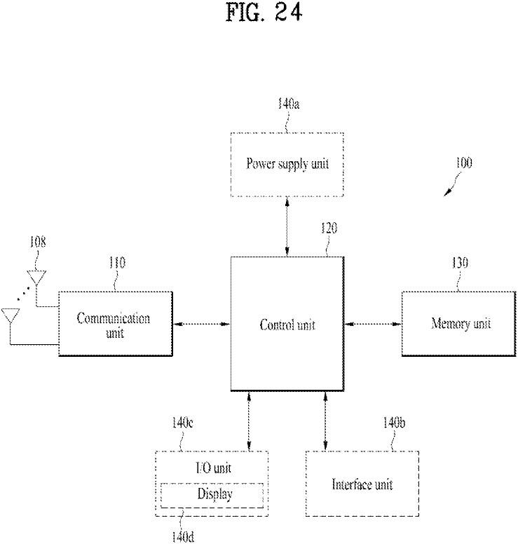

FIG. 24 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 24, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to140c correspond to the blocks 110 to 130/140 of FIG. 23, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

### Examples of Vehicles or Autonomous Vehicles to Which the Present Disclosure Is Applied

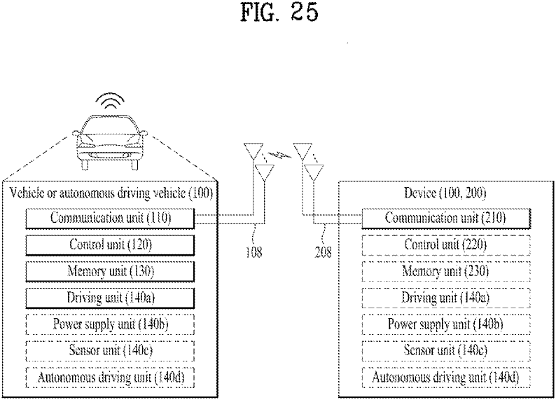

FIG. 25 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 25, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 23, respectively

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-described embodiments of the present disclosure are applicable to various mobile communication systems.

1. A method of receiving resource allocation, by a user equipment (UE), in a wireless communication system, the method comprising:
reporting capability information related to the resource allocation for the UEto a base station;
receiving a Physical Downlink Control Channel (PDCCH) including Downlink Control Information (DCI) for scheduling resource allocation information from the base station;
receiving a Physical Downlink Shared Channel (PDSCH) based on the resource allocation information; and
transmitting a Physical Uplink Shared Channel (PUSCH) based on the resource allocation information,
wherein the resource allocation information includes a preconfigured time resource duration divided into a first time resource duration and a second time resource duration,
wherein the capability information includes information on a self-interference cancellation capability related to a Full Duplex Radio (FDR), wherein the first time resource duration is allocated in relation to the FDR, the second time resource duration is allocated for either the PDSCH or the PUSCH , and
wherein the first time resource duration and the second time resource duration are determined based on the self-interference cancellation capability, a first data amount related to the PUSCH, and a second data amount related to the PDSCH.

2. The method of claim 1, wherein for the PDSCH, a first modulation and coding scheme (MCS) and a second MCS are applied to the first time resource duration and the second time resource duration, respectively, based on the second data amount being greater than the first data amount.

3. The method of claim 2, wherein the first MCS and the second MCS are obtained based on the resource allocation information.

4. The method of claim 2, wherein the first MCS is determined based on a reference signal received power (RSRP), a signal to interference noise ratio (SINR), and the self-interference cancellation capability measured by the UE.

5. The method of claim 4, wherein information on the first MCS is determined based on SINRFD calculated from the following equation:
$$S I N {R}_{F D} = \frac{R S R P \times S I N R}{R S R P + \left(T P \times S {I}^{i}\right) \times S I N R} ,$$
where SIⁱ denotes the self-interference cancellation capability and TP denotes a transmit power.

6. The method of claim 1, wherein a length of the first time resource duration is determined based on a smaller of the first data amount and the second data amount.

7. The method of claim 1, wherein a length of the second time resource duration is determined based on a difference between the first data amount and the second data amount.

8. The method of claim 1, wherein the resource allocation information further comprises information on an offset for specifying the first time resource duration.

9. The method of claim 8, wherein the offset is a difference between a start timing of the first time resource duration and a start timing of the predetermined time resource duration.

10. The method of claim 1, wherein based on the second data amount being smaller than the first data amount, the PUSCH is transmitted by applying a first modulation and coding scheme (MCS) and a second MCS to the first time resource duration and the second time resource duration, respectively.

11. The method of claim 1, wherein the resource allocation information is received in downlink control information (DCI).

12. The method of claim 1, wherein a frequency band related to a first orthogonal frequency division multiplexing (OFDM) symbol corresponds to a frequency band related to the second time resource duration.

13. A method of allocating, by a base station, resources to a user equipment (UE) in a wireless communication system supporting full-duplex radio (FDR), the method comprising:
receiving capability information related to the resource allocation for the UE from the UE;
transmitting a Physical Downlink Control Channel (PDCCH) including Downlink Control Information (DCI) for scheduling resource allocation information ; and
transmitting a Physical Downlink Shared Channel (PDSCH) based on the resource allocation information; and
receiving a Physical Uplink Shared Channel (PUSCH) based on the resource allocation information,
wherein the resource allocation information includes a preconfigured time resource duration divided into a first time resource duration and a second time resource duration,
wherein the capability information includes information on a self-interference cancellation capability related to a Full Duplex Radio (FDR), wherein the first time resource duration is allocated in relation to the FDR, the second time resource duration is allocated for either the PDSCH or the PUSCH, and
wherein the first time resource duration and the second time resource duration are determined based on the self-interference cancellation capability, a first data amount related to the PUSCH, and a second data amount related to the PDSCH.

14. A user equipment (UE) configured to receive allocation of resources in a wireless communication system supporting full-duplex radio (FDR), the UE comprising:
a radio frequency (RF) transceiver; and
a processor connected to the RF transceiver,
wherein the processor is configured to control the RF transceiver to report capability information related to the resource allocation for the UE to a base station, receive a Physical Downlink Control Channel (PDCCH) including Downlink Control Information (DCI) for scheduling resource allocation information from the base station, receive a Physical Downlink Shared Channel (PDSCH) based on the resource allocation information, and transmit a Physical Uplink Shared Channel (PUSCH) based on the resource allocation information,
wherein the resource allocation information includes a preconfigured time resource duration divided into a first time resource duration and a second time resource durationte ,
wherein the capability information includes information on a self-interference cancellation capability related to a Full Duplex Radio (FDR), wherein the first time resource duration is allocated in relation to the FDR, the second time resource duration is allocated for either the PDSCH or the PUSCH, and
wherein the first time resource duration and the second time resource duration are determined based on the self-interference cancellation capability, a first data amount related to the PUSCH, and a second data amount related to the PDSCH.

15. (canceled)
